(19) United States
(12) Patent Application Publication
(10) Pub. No.: US 2014/0173948 A1
(43) Pub. Date: Jun. 26, 2014

(54) EXCAVATING TOOTH WEAR INDICATOR AND METHOD

(71) Applicant: VOLVO CONSTRUCTION EQUIPMENT AB, Eskilstuna (SE)

(72) Inventors: Suksan Ok, Carlisle, PA (US); Kevin F. Luft, Biglerville, PA (US)

(21) Appl. No.: 14/236,925

(22) PCT Filed: Aug. 26, 2011
(86) PCT No.: PCT/US2011/049295

§ 371 Date: Feb. 4, 2014

(51) Int. Cl. E02F 9/28; B23P 6/00

(52) U.S. Cl. CPC E02F 9/2808; B23P 6/00
USPC 37/452; 29/402.08

(57) ABSTRACT

The present invention relates to an excavating tooth for construction machinery and a method for replacing an excavating tooth of construction machinery. The excavating tooth is provided with a working end and a mountable end. The mountable end defines a means for receiving an adaptor mounted on a work tool. The working end defines a bore. A wear indicator is located within the bore and provided with a length that is less than an unworn length of the working end and a color that visibly contrasts with a color of the working end. As the excavating tooth is worn down during use, the wear indicator becomes visible to provide a visual indication of the need to replace the excavating tooth.

### FIELD OF THE INVENTION

The present invention relates to a wear indicator system for excavating teeth on construction machinery.

### BACKGROUND OF THE INVENTION

Construction machinery, including, for example, skid steers, excavators, dozers, and loaders, may be provided with a work tool in the form of a bucket or blade. Often times the leading edge of such a bucket or blade is outfitted with a plurality of excavating teeth. For purposes of securing the excavating teeth to the bucket or blade, the excavating teeth typically mate with an adaptor provided on the bucket or blade. By way of example, a forward lower lip on a bucket may be provided with a series of adaptors and excavating teeth that extend along the length of the lip.

During use, the excavating teeth are subjected to abrasive wear, which requires that the excavating teeth be replaced from time to time. Failure to timely replace the excavating teeth may result in damage to the adaptors, which are generally more expensive to replace than just the excavating teeth. While the timely replacement of the excavating teeth is important, replacing the excavating teeth too early may entail using less than the full useful life, which also increases costs. For this reason, a variety of systems have been proposed for purposes of indicating wear or the need for replacement of excavating teeth.

U.S. Pat. No. 5,144,762 shows an arrangement wherein wear indicating ribs located on the adaptor appear through openings in the excavating tooth that form as the excavating tooth is worn down. While the wear indicating ribs provide an indication of wear, this system is not easily adaptable to existing machines since it requires special adaptors that include the wear indicating ribs. This solution also requires that the excavating teeth have a large void in the region that extends around the wear indicating ribs, which, in turn, weakens the teeth at a critical area that is subjected to relatively large loads. Moreover, this solution risks exposing the adaptors to unnecessary wear since the wear indicating ribs are on the adaptor itself and must be exposed, and thus subject to the possibility of wear, before any sort of visual indication can occur. Additionally, as the teeth “hole out” to expose the wear indicating ribs, debris may pack the holes, thus obscuring the wear indicating ribs and possibly damaging the adaptors.

Similarly, U.S. Pat. No. 6,032,390 shows an arrangement wherein large voids in the teeth are positioned to become visible as the teeth erode due to wear. The system is designed to allow each excavating tooth to “hole out” without damaging the load bearing area of the adaptors; however, as the teeth “hole out”, debris may pack the holes, thus obscuring the appearance of the holes and possibly damaging the adaptors. This solution also requires that the excavating teeth define a large void in the region that extends around the adaptor, which, in turn, weakens the teeth at a critical area that is subjected to relatively large loads.

The present invention is directed at an improved wear indicator system for excavating teeth.

### SUMMARY OF THE INVENTION

According to one embodiment of the present invention, an excavating tooth for construction machinery comprises an excavating tooth provided with a working end and a mountable end. The mountable end defines a means for receiving an adaptor mounted on a work tool. The working end defines a bore. A wear indicator is located within the bore and provided with a length that is less than an unworn length of the working end and a color that visibly contrasts with a color of the working end.

According to another embodiment of the present invention, a method of replacing an excavating tooth on a working tool of a construction machine wherein the working tool is provided with an adaptor, the excavating tooth is provided with a working end and a mountable end, the mountable end defines a recess that receives the adaptor, the working end defines a bore and is provided with a unworn length and a worn length, a wear indicator is located in the bore and includes a length that is less than the unworn length and a color that contrasts with a color of the working end, comprises the steps of abrasively wearing down the excavating tooth from the unworn length to the worn length, whereby the wear indicator becomes visible and replacing the excavating tooth after the wear indicator becomes visible.

According to another embodiment of the present invention, an excavating tooth for construction machinery comprises an excavating tooth provided with a working end and a mountable end. The mountable end defines an adaptor receiving recess. The working end defines a bore. A wear indicator is located within the bore and provided with a length that is less than an unworn length of the working end and greater than or equal to a worn length of the working end and
a color that visibly contrasts with a color of the working end of the excavating tooth.

### ASPECTS

According to one aspect of the present invention, an excavating tooth for construction machinery comprises:

an excavating tooth provided with a working end and a mountable end,

the mountable end defining a means for receiving an adaptor mounted on a work tool;

the working end defining a bore; and

a wear indicator that is located within the bore and provided with:
a length that is less than an unworn length of the working end; and
a color that visibly contrasts with a color of the working end.

Preferably, the wear indicator is a flowable material and the bore includes an inner end that is plugged to prevent the wear indicator from flowing into the mountable end.

Preferably, the wear indicator is an epoxy.

Preferably, the wear indicator is a metal.

Preferably, the wear indicator is a plastic.

Preferably, the wear indicator is a flowable adhesive.

According to another aspect of the present invention, a method of replacing an excavating tooth on a working tool of a construction machine wherein the working tool is provided with an adaptor, the excavating tooth is provided with a working end and a mountable end, the mountable end defines a recess that receives the adaptor, the working end defines a bore and is provided with a unworn length and a worn length, a wear indicator is located in the bore and includes a length that is less than the unworn length and a color that contrasts with a color of the working end, comprises the steps of:

abrasively wearing down the excavating tooth from the unworn length to the worn length, whereby the wear indicator becomes visible; and

replacing the excavating tooth after the wear indicator becomes visible.

Preferably, the wear indicator is a flowable material and the bore includes an inner end that is plugged to prevent the wear indicator from flowing into the mountable end.

Preferably, the wear indicator is an epoxy.

Preferably, the wear indicator is a metal.

Preferably, the wear indicator is a plastic.

Preferably, the wear indicator is a flowable adhesive.

According to yet another aspect of the present invention, an excavating tooth for construction machinery comprises:

an excavating tooth provided with a working end and a mountable end,

the mountable end defining an adaptor receiving recess;

the working end defining a bore; and

a wear indicator that is located within the bore and provided with:
a length that is less than an unworn length of the working end and greater than or equal to a worn length of the working end; and
a color that visibly contrasts with a color of the working end.

Preferably, the wear indicator is a flowable material and the bore includes an inner end that is plugged to prevent the wear indicator from flowing into the mountable end.

Preferably, the wear indicator is an epoxy.

Preferably, the wear indicator is a metal.

Preferably, the wear indicator is a plastic.

Preferably, the wear indicator is a flowable adhesive.

### BRIEF DESCRIPTION OF THE DRAWINGS

FIG. 1 depicts a side perspective view of a construction work machine according to one embodiment of the present invention.

FIG. 2A depicts a perspective view of a work tool according to one embodiment of the present invention.

FIG. 2B depicts a close up view of excavating tooth assemblies shown in FIG. 2A,

FIG. 3 depicts a sectional view of an excavating tooth according to one embodiment of the present invention.

FIG. 4 depicts a sectional view of an excavating tooth assembly according to one embodiment of the present invention.

FIG. 5 depicts a sectional view of an excavating tooth assembly according to one embodiment of the present invention.

FIG. 6 depicts a sectional view of an excavating tooth assembly according to one embodiment of the present invention.

FIG. 7 depicts a sectional view of an excavating tooth assembly according to one embodiment of the present invention.

### DETAILED DESCRIPTION OF THE INVENTION

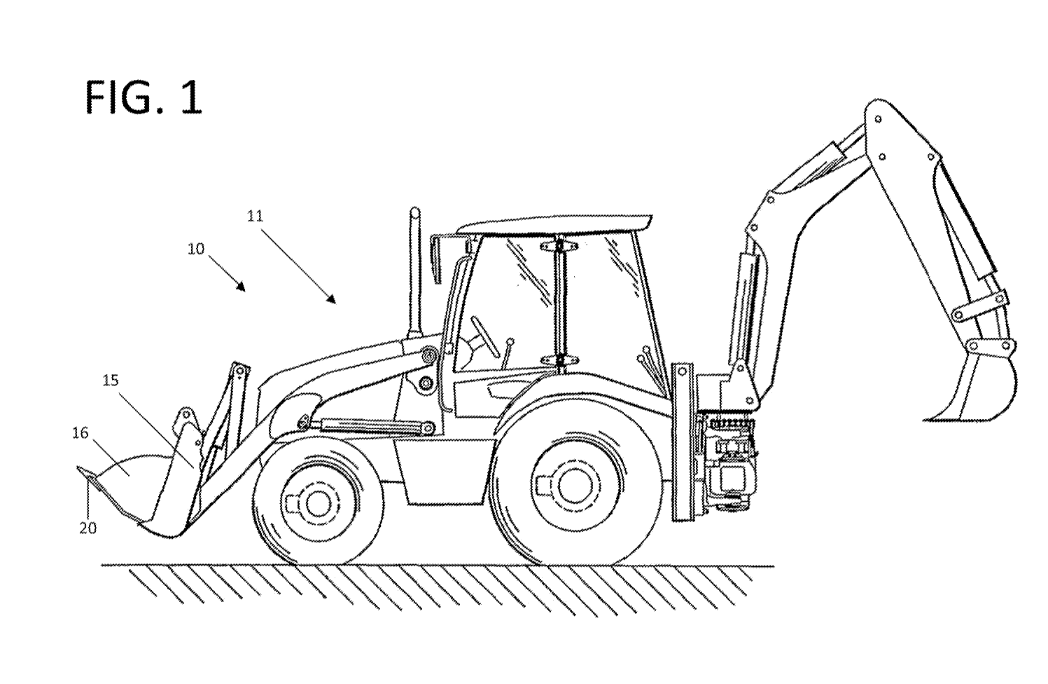

FIG. 1 depicts a construction work machine 10 according to one embodiment of the present invention. As shown therein, the construction work machine 10 may be a loader 11. Also shown, the construction work machine 10 is provided with at least one work tool 15, which in the present embodiment is shown as a bucket 16 for excavating and/or moving a material, such as, for example, gravel or earth.

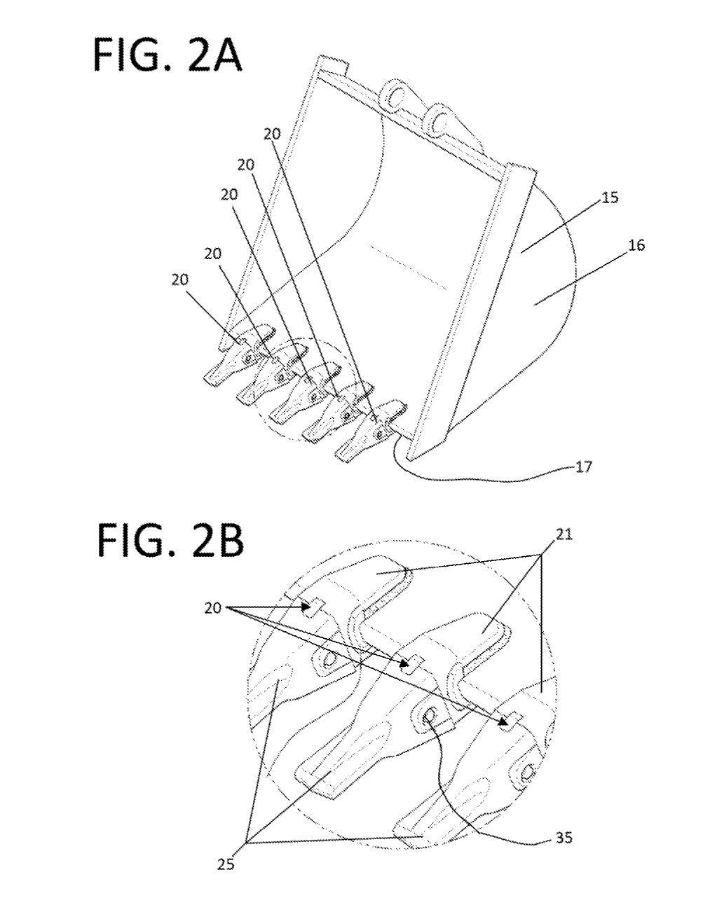

As shown in FIGS. 1-2B, the work tool 15 is provided with at least one excavating tooth assembly and preferably a plurality of excavating tooth assemblies, as at 20. As FIG. 2 best illustrates, the excavating tooth assemblies 20 are each provided with an adaptor 21 and an excavating tooth 25. According to one aspect of the present embodiment, the adaptor 21 functions as an interface that releasably secures the excavating tooth 25 to the work tool 15.

As shown in FIG. 2, the adaptor 21 may be secured to the forward lower lip 17 of the work tool 15. Those of ordinary skill in the art will appreciate that the adaptor 21 may be secured to the work tool 15 in any suitable manner, but is preferably secured in a releasable manner that allows the adaptor 21 to be replaced, when worn or damaged, if necessary.

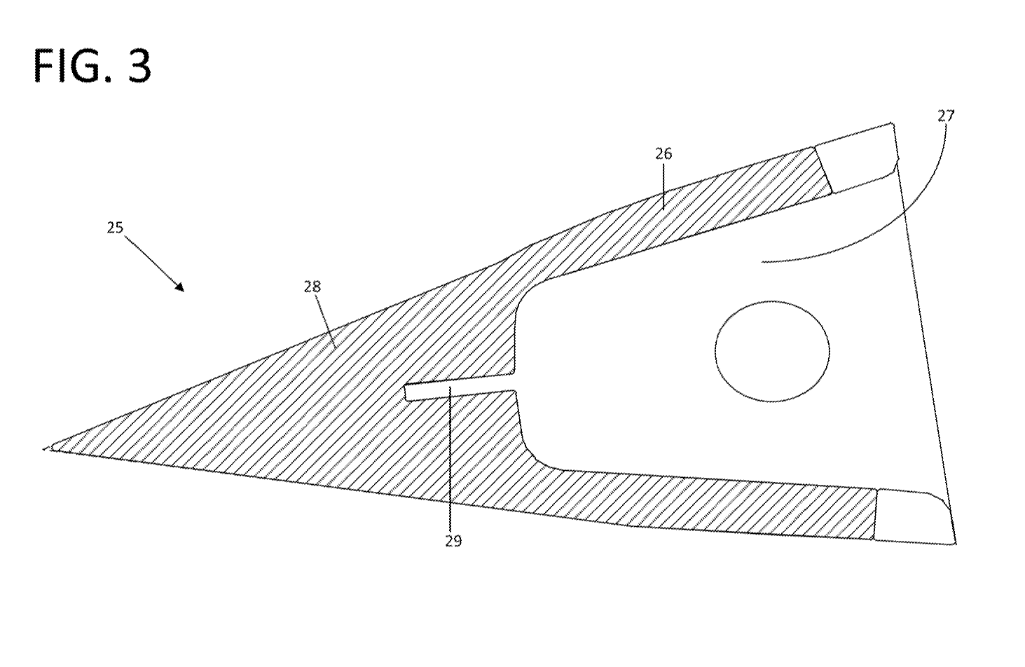

Also, shown in FIG. 3, the excavating tooth 25 is provided with means for receiving the adaptor 21. In the present embodiment, the excavating tooth 25 is provided with a mountable end 26 that defines an internal adaptor receiving recess 27 that receives the adaptor 21. While it is within the scope of the present embodiment to secure the excavating tooth 25 to the adaptor 21 in any fashion, as shown, a removable retaining pin 35 may releasably secure the excavating tooth 25 to the adaptor 21.

Advantageously, the excavating tooth 25 of the present embodiment includes a wear indicator 50 that becomes visible as the excavating tooth 25 is worn down due to abrasive wear. In the present embodiment, the excavating tooth 25 is provided with a working end 28 that extends away from the adaptor 21 and the mountable end 26. As shown, in FIGS. 3-5, the working end 28 defines a bore 29 that receives the wear indicator 50, whereby the wear indicator 50 is located internally within the working end 28.

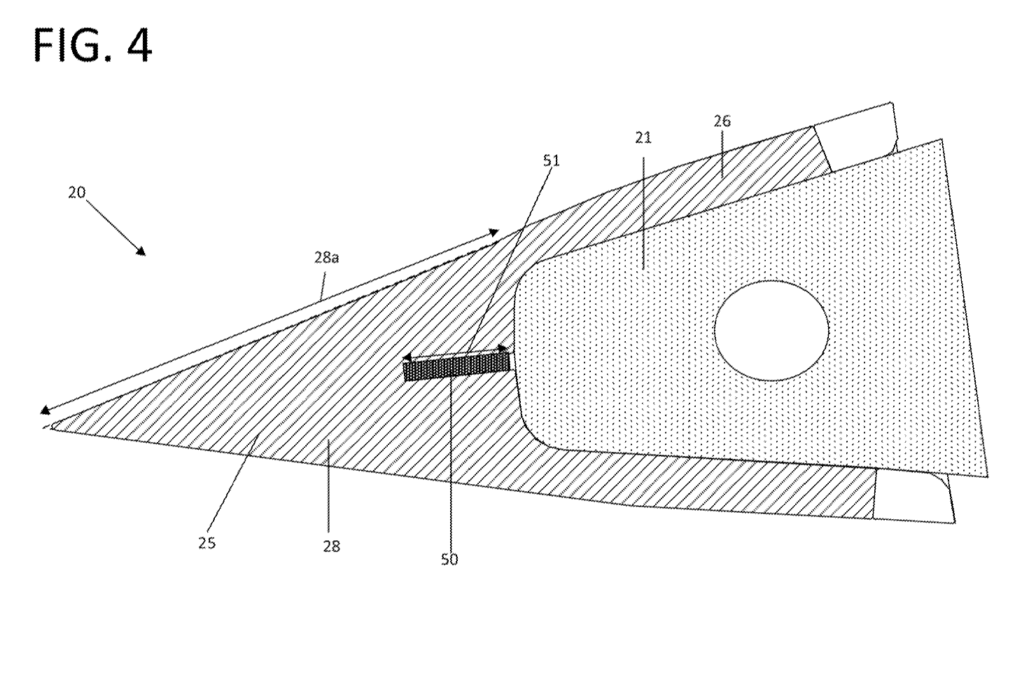

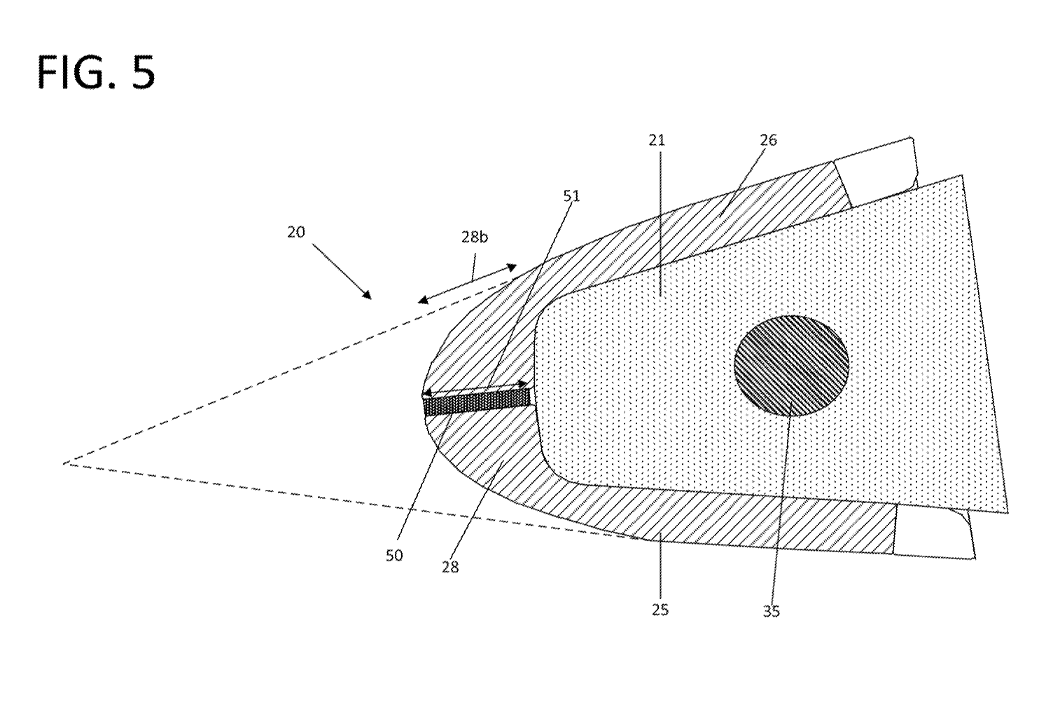

As shown, in FIG. 4, the wear indicator 50 is provided with a length 51 that is less than an unworn length 28a of the working end 28 of the tooth 25. As shown in FIG. 5, the length 51 of the wear indicator 50 is greater than or equal to a worn length 28b of the working end, Advantageously, as shown by a comparison of FIGS. 4 and 5, as the working end 28 is worn down due to abrasive wear, the unworn length 28a of the working end 26 is reduced to a worn length 28b and the wear indictor 50 becomes visible. Advantageously, the wear indictor 50 is provided with a color that contrasts with the color of the working end 28. Accordingly, once visible, the wear indicator 50 provides a clear visual indication to an operator, for example, that the excavating tooth 25 should be replaced. Advantageously, the visual indication occurs before damage to the adaptor 21 can occur due to wear to the working end 26 of the excavating tooth 25.

Within the scope of the present invention, the wear indicator 50 or 50′ may be fabricated from any material that contrasts with the color of the working end 28. By way of example, and not limitation, the wear indicator 50 may be fabricated from a metal, plastic, an epoxy. By way of another example, and not limitation, the wear indicator 50′ may be fabricated from a colored flowable adhesive that hardens upon exposure to air and adheres to the outer surface 29 of the excavating tooth 25.

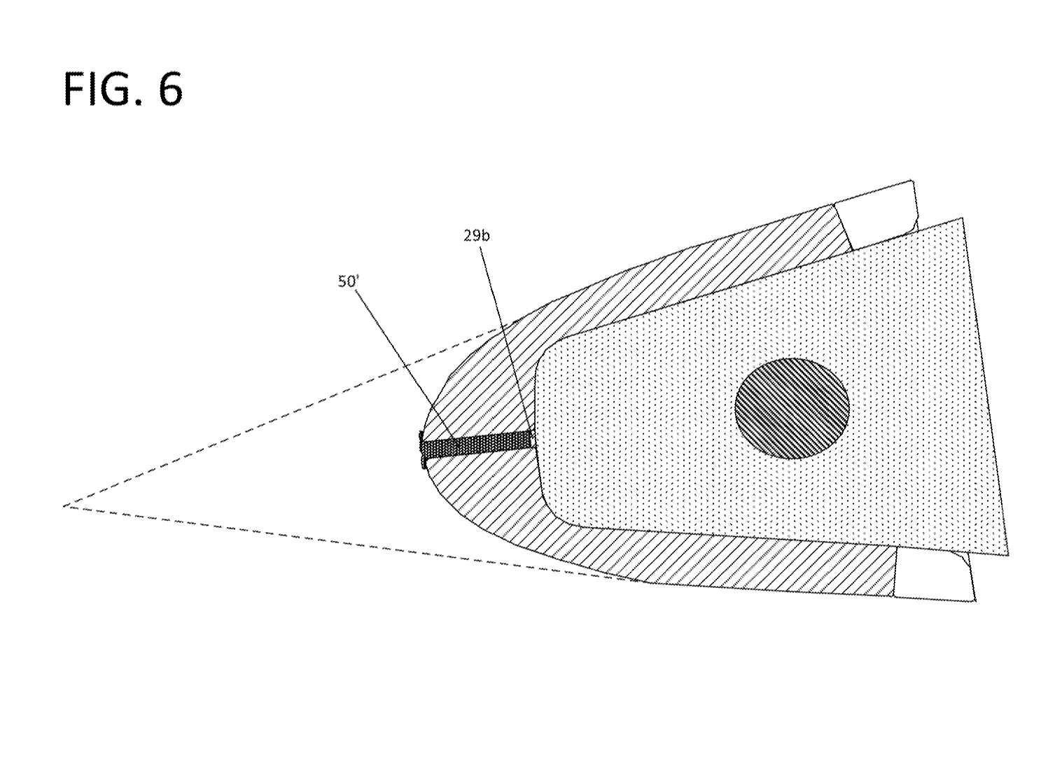

Turning now to FIG. 6, an alternative embodiment similar to the embodiments shown in FIGS. 1-5 is shown, except that a wear indicator 50′ is a flowable material. As shown in FIG. 6, in the present embodiment, the wear indicator 50′ flows out from the bore 29 as the working end 28 is worn down due to abrasive wear and the wear indictor 50′ becomes visible. Advantageously, the wear indicator 50′ may flow out from the bore and coat the outer surface 25a of the excavating tooth 25 to provide a greater degree of visual indication. As shown, the inner end 28a of the bore 29 may be plugged as at 29b in order to prevent the wear indicator 50′ from flowing into the adaptor receiving recess 27 or into the mountable end 26.

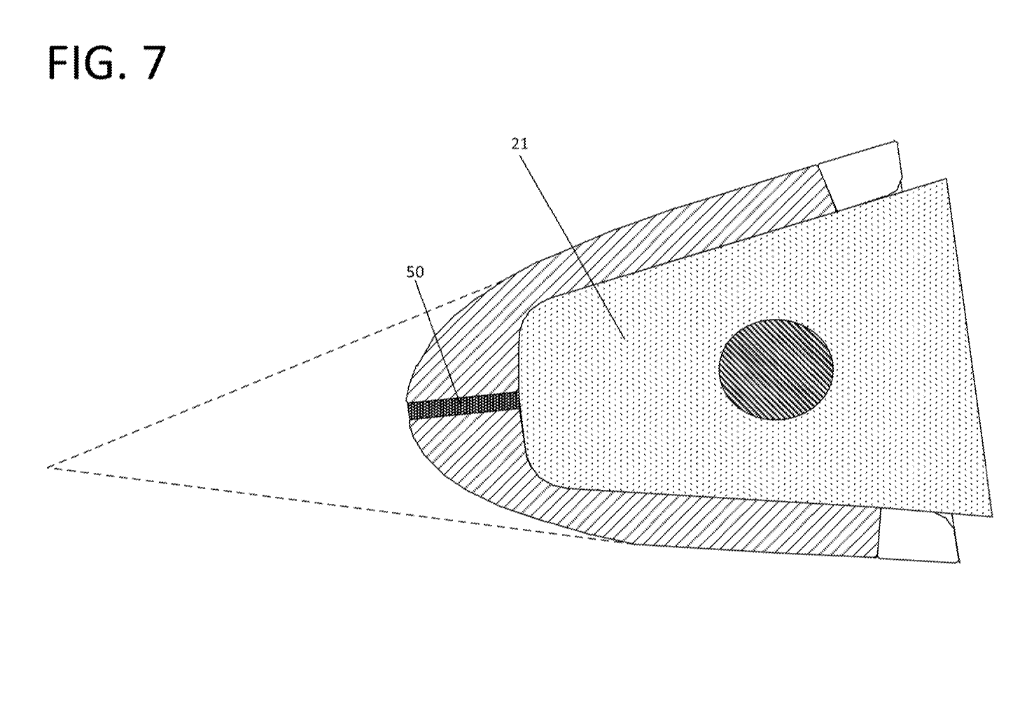

The detailed descriptions of the above embodiments are not exhaustive descriptions of all embodiments contemplated by the inventors to be within the scope of the invention. The present description depicts specific examples to teach those skilled in the art how to make and use the best mode of the invention. Those skilled in the art will appreciate variations from these examples that fall within the scope of the invention, By way of example, and not limitation, although FIGS. 1-5 show a small gap between the wear indicator 50 and the adaptor, as shown in FIG. 7, the wear indicator 50 may abut the adaptor 21.

Persons skilled in the art will recognize that certain elements of the above-described embodiments and examples may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention. Thus, although specific embodiments of, and examples for, the invention are described herein for illustrative purposes, various equivalent modifications are possible within the scope of the invention, as those skilled in the relevant art will recognize. Accordingly, the scope of the invention is determined from the appended claims and equivalents thereof.

We claim:

1. An excavating tooth for construction machinery, comprising:
an excavating tooth provided with a working end and a mountable end,
the mountable end defining a means for receiving an adaptor mounted on a work tool;
the working end defining a bore; and
a wear indicator that is located within the bore and provided with:
a length that is less than an unworn length of the working end; and
a color that visibly contrasts with a color of the working end.

2. The excavating tooth according to claim 1, wherein:
the wear indicator is a flowable material; and
the bore includes an inner end that is plugged to prevent the wear indicator from flowing into the mountable end.

3. The excavating tooth according to claim 1, wherein the wear indicator is an epoxy.

4. The excavating tooth according to claim 1, wherein the wear indicator is a metal.

5. The excavating tooth according to claim 1, wherein the wear indicator is a plastic.

6. The excavating tooth according to claim 1, wherein the wear indicator is a flowable adhesive.

7. A method of replacing an excavating tooth on a working tool of a construction machine wherein the working tool is provided with an adaptor, the excavating tooth is provided with a working end and a mountable end, the mountable end defines a recess that receives the adaptor, the working end defines a bore and is provided with a unworn length and a worn length, a wear indicator is located in the bore and includes a length that is less than the unworn length and a color that contrasts with a color of the working end, the method comprising the steps of:
abrasively wearing down the excavating tooth from the unworn length to the worn length, whereby the wear indicator becomes visible; and
replacing the excavating tooth after the wear indicator becomes visible.

8. The method according to claim 7, wherein:
the wear indicator is a flowable material; and
the bore includes an inner end that is plugged to prevent the wear indicator from
flowing into the mountable end.

9. The method according to claim 7, wherein the wear indicator is an epoxy.

10. The method according to claim 7, wherein the wear indicator is a metal.

11. The method according to claim 7, wherein the wear indicator is a plastic.

12. The method according to claim 7, wherein the wear indicator is a flowable adhesive.

13. An excavating tooth for construction machinery, comprising:
an excavating tooth provided with a working end and a mountable end,
the mountable end defining an adaptor receiving recess;
the working end defining a bore; and
a wear indicator that is located within the bore and provided with:
a length that is less than an unworn length of the working end and greater than or equal to a worn length of the working end; and
a color that visibly contrasts with a color of the working end.

14. The excavating tooth according to claim 13, wherein:
the wear indicator is a flowable material; and
the bore includes an inner end that is plugged to prevent the wear indicator from flowing into the mountable end.

15. The excavating tooth according to claim 13, wherein the wear indicator is an epoxy.

16. The excavating tooth according to claim 13, wherein the wear indicator is a metal.

17. The excavating tooth according to claim 13, wherein the wear indicator is a plastic.

18. The excavating tooth according to claim 13, wherein the wear indicator is a flowable adhesive.
